(19) United States
(12) Patent Application Publication
(10) Pub. No.: US 2024/0066334 A1
(43) Pub. Date: Feb. 29, 2024

(54) PROTECTIVE MASK COMPRISING A CONDUCTOR FABRIC

(71) Applicant: AVIBAS AG, Sarnen (CH)

(72) Inventors: Jürgen MÖLLMANN, Trasadingen (CH); Chahan YERETZIAN, Allenwinden (CH); Omer HRORI, Nussloch (DE)

(21) Appl. No.: 18/260,150

(22) PCT Filed: Jan. 6, 2022
(86) PCT No.: PCT/EP2022/050179

§ 371 Date: Jun. 30, 2023

(30) Foreign Application Priority Data
Jan. 6, 2021 (CH) 00006/21

(51) Int. Cl. A62B 23/02; A41D 13/11; A62B 18/08; B32B 5/02; B32B 5/26; B32B 37/10; B32B 37/12; B32B 37/16; D04H 1/4242; D04H 1/4334; D04H 1/4382; D06M 17/00

(52) U.S. Cl. CPC A62B 23/025; A41D 13/11; A62B 18/08; B32B 5/022; B32B 5/266; B32B 37/10; B32B 37/1207; B32B 37/16; D04H 1/4242; D04H 1/4334; D04H 1/43828; D04H 1/43835; D06M 17/00; D06M 2101/34; D10B 2401/16; D10B 2509/00

(57) ABSTRACT

The present invention relates to a protective mask (1) comprising: a mask body (10) which is designed to be worn by a person so as to cover the mouth and the nose of said person, the mask body having a first layer comprising an electrically conductive conductor fabric (20); a current coupling structure (30) through which an electric current is supplied; and the protective mask being configured to generate a current flow through the conductor fabric by means of the electric current.

### FIELD

The invention relates to a protective mask with an electrically conductive fabric to be used as protection against pathogens such as viruses and bacteria.

### BACKGROUND

Conventionally, medical face masks and particle-filtering half masks are typically used as protective masks against pathogens such as viruses or bacteria.

Medical face masks are designed for foreign protection and protect the surrounding of a carrier of the mask, among other things, from exposure of infectious droplets usually by means of a filter fleece. In addition, these masks also protect the carrier of the mask itself. Since, depending on the fit of the medical face mask, the carrier may not only inhale and exhale through the filter fleece, but the respiratory air may be drawn in and delivered past the edges of the mask as a leakage stream, medical face masks often do not provide adequate protection against pathogen-containing aerosols or other small particles.

Particle filtering half masks (FFP masks or Filtering Face Piece masks) typically have the purpose of protecting the carrier of the mask from particles, droplets and aerosols. The structure of particle-filtering half-masks is different. For example, there are masks without exhalation valve and masks with exhalation valve. Masks without an exhalation valve filter both the inhaled air and the exhaled air and therefore provide both self-protection and external protection, although they are primarily designed for self-protection. FFP masks with a valve only filter the inhaled air and therefore offer only rather limited external protection.

FFP masks may also have an electrostatically charged fabric made of fine fibers. This fabric can filter out or electrostatically retain particles smaller than a thousandth of a millimeter. Often, such FFP masks have another protective shell with mask grid, which allows a comfortable and secure fit.

With all known protective masks, the viruses and bacteria remain mostly alive in the fabric or the filter. Therefore, such masks should be changed after some time. But even with regular changes, pathogens can be spread from the masks, particularly if they are not handled properly. In addition, breathing can be severely impaired due to the fine fibers of the fabric in several layers.

The object of the present invention is therefore to propose a protective mask that effectively eliminates or destroys pathogens such as viruses and bacteria, and that reduces or even eliminates their spread as completely as possible, and preferably offers improved wearing comfort.

### SUMMARY

According to the invention, the object is solved by a protective mask as defined in independent claim 1 and by the various aspects of the invention as described below. Advantageous embodiments of the invention are apparent from the dependent claims and the following description.

In a first aspect, the present invention is a protective mask having a mask body and a current coupling structure. The mask body is designed to be worn by a carrier so that it covers the mouth and nose of the person. The mask body has a first layer having an electrically conductive conductor fabric. An electric current can be injected into the mask body via the current coupling structure so that a current flow is generated through the conductor fabric.

The term “conductor fabric” refers to a textile, for example made of polyamide among other materials, which is electrically conductive. The term comprises not only woven textiles in the narrower sense, but all forms of and also nonwoven textiles. In particular, the conductor fabric may be a non-woven fabric. A fabric can be electrically conductive by comprising electrically conductive fibers. Alternatively, or additionally, conductivity can be increased or provided in the first place by coating with metal. For example, the metal may be or have a pure or high percentage silver.

The term “fibers” in the context of the invention comprises comparatively short, quasi-linear, thread-like structures as well as longer structures such as yarns or similar.

The term “current coupling structure” refers to an element or embodiment through which an electrical energy source can inject current to provide the electrical current to the conductive fabric. The current coupling structure can be designed as a current connector and have, for example, two latching elements to which the poles of the electrical energy source can be latched. It can also be designed as a fixed wiring through which, for example, the electrical energy source is connected to the conductor fabric. Or it can be the poles of a battery or similar electrical energy source applied directly to the conductor fabric.

By designing the protective mask of the first aspect of the invention to actively generate the current flow in the protective mask or mask body thereof, pathogens such as viruses and bacteria can be rendered harmless at or through the conductive fabric. In particular, the current flow can cause proteins or the cell wall of the pathogens to be destroyed. By means of the active generation of the current flow, a particularly high efficiency in the destruction of the pathogens can be ensured. For example, tests have shown that even after a comparatively short period of time, such as less than five minutes, a comparatively large proportion of pathogens, such as more than 95%, are harmless without the carrier or user of the protective mask being affected by the current flow. The pathogens can therefore be actively killed or incapacitated and remain permanently or forever inactive.

In comparison, pathogens in conventional masks are typically only filtered and still remain active in the fabric of the masks. However, the protective mask now makes it possible to prevent pathogens from being spread in any way, or to minimize such spread, since the pathogens are rendered harmless immediately as they flow out of the mouth or nose, or before they flow into the mouth or nose. The outgoing or incoming breathing air is thus sterilized. In addition, the protective mask or mask body according to the present invention does not need to be changed frequently compared to conventional masks.

The protective mask may comprise a control unit and an electrical energy source electrically connected to the current coupling structure. The electrical connection can be realized directly, for example via a conduit or cable, or indirectly, for example via other components. For example, the control unit may be electrically connected directly to the electrical energy source and the current coupling structure, so that at the same time the electrical energy source is indirectly connected to the current coupling structure via the control unit. The electrical energy source can thus supply the protective mask with electrical current via the current coupling structure. The control unit can control the current flow through the conductor fabric as required or regulate the current supply.

The term “electrical energy source” means a source that provides electrical energy in the form of electrical current. It can be designed as a current source or a voltage source. Preferably, the electrical energy source comprises a battery, for example a commercially available battery, which is preferably rechargeable. Such a battery allows easy independent and portable design of the protective mask. Additionally, or alternatively, the electrical energy source may comprise a photovoltaic cell. Via such a photovoltaic cell, electricity can be supplied directly to power the current coupling structure, or the battery can be charged by means of the photovoltaic cell.

The term “control unit” may refer to an electrical controller that controls or triggers the flow of current in the conductor fabric. For example, it can switch the current flow on and off, set the intensity of the current flow such as current intensity or amplitude of the electric current, or define the shape of the current flow.

The control unit and the electrical energy source can be arranged outside the mask body. For example, they may be connected to the current coupling structure of the protective mask by a cable and feed the electrical current through the cable. Thus, the weight of the protective mask can be reduced. In addition, a separate electrical energy source may have a higher capacity or power when not fastened to the mask body or when not part of the protective mask.

However, the electrical energy source is advantageously arranged in or on the mask body. For example, it can be placed as a battery embedded in the conductor fabric or mounted on the mask body in a replaceable manner with advantage. Or it may comprise a photovoltaic cell, which can be used to convert light into electricity.

Preferably, the protective mask comprises at least one housing and the mask body is preferably provided with at least one holder. The at least one housing is attached to the at least one holder of the mask body. In this case, the at least one housing can be detachably or removably attached to the at least one holder. The at least one housing may enclose or wrap the control unit and the electrical energy source when attached to the at least one holder, such that these two components are integrated together with the at least one housing and are thus removably attached to the holder of the mask body. In this manner, the entire protective mask can be provided as a single unit, wherein the electrical energy source and control unit are protected but still replaceable or removable as needed.

Preferably, the at least one housing comprises two housings and the at least one holder comprises two holders. The control unit can thus be arranged in one housing and the electrical energy source in the other housing. Alternatively, a first of the two housings may enclose the control unit or components of the control unit and the electrical energy source or components of the electrical energy source, and a second of the two housings may enclose a further control unit or further components of the control unit and a further electrical energy source or further components of the electrical energy source. Advantageously, the two holders are arranged on the mask body in such a manner that the housings and their contents are distributed in a balanced manner on the protective mask, so that a quasi-uniform weight distribution can be achieved. For example, the two housings may each be arranged in a lateral area of the mask body. These lateral areas can each be located close to an ear of the carrier or user when the protective mask is in use.

Preferably, the control unit and the electrical energy source are designed to inject the electrical current into the mask body in a clocked manner via the current coupling structure. The term “clocked” may refer to the fact that the electric current is injected into the mask body in pulses. Thereby, such a pulse can correspond to a clock pulse. A clock pulse of the electric current preferably lasts between approximately 2 seconds and approximately 10 seconds, and in particular approximately 5 seconds. By feeding the electrical current into the mask body in a clocked manner, a pulsating current flow can be generated in the mask body or conductor fabric. This can promote efficient rendering harmless of disease carriers in the mask body. In addition, this can reduce power consumption and thus increase the runtime of the protective mask.

Further, the control unit and the electrical energy source may be designed to inject the electrical current in varying amperage into the mask body via the current coupling structure. The current intensity is typically defined or limited by the electrical resistance of the conductor fabric and the voltage provided by the electrical energy source. In this manner, the efficiency of rendering pathogens harmless in the mask body can be further improved.

In particular, the control unit and the electrical energy source can additionally be designed to feed the electrical current into the mask body in the form of Gaussian waves in a clocked manner via the current coupling structure. In this manner, current can be applied to the mask body in a manner similar to earthquake waves or shock waves, which enables particularly efficient elimination of viruses and other pathogens in the mask body.

Preferably, the protective mask has a signal unit electrically connected to the control unit, wherein the control unit is designed to activate the signal unit when a capacity of the electrical energy source is below a predefined minimum capacity value. For example, the signal unit may have an illuminant such as an LED that can be used to generate an optical signal. The capacity of the electrical energy source may in particular be a charge level if the electrical energy source is provided as a battery. For example, voltage provided by the electrical energy source may represent its capacitance. Accordingly, the minimum capacity value may be, for example, a minimum voltage provided by the electrical energy source. If the voltage provided by the electrical energy source or battery falls below the minimum voltage, the control unit activates the signal unit. By means of the signal unit, the user or carrier of the mask can thus be informed about the capacity of the electrical energy source, such as the charge level of the battery. This prevents the protective mask from being unintentionally less effective due to an interrupted or insufficiently powerful power supply.

Preferably, the protective mask has a humidity sensor electrically connected to the control unit and coupled to the conductor fabric, wherein the control unit is designed to inject the electrical current into the mask body via the current coupling structure when a humidity detected by the humidity sensor is above a predefined base humidity value. The basic humidity value can be, for example, a relative humidity in percent. The humidity in the conductor fabric can provide an indication of whether or not the protective mask is being worn. When a user wears the protective mask as intended, he breathes through the conductor fabric, which increases the humidity in the conductor fabric. In this manner, the current flow in the conductor fabric can be started automatically as soon as the user wears the protective mask. Manual switching on or off is not necessary.

Preferably, the electrical energy source comprises a battery. By means of the battery, the electrical energy source can be efficiently designed to be portable. Due to the relatively low power consumption of the protective mask, the battery can be comparatively small, which allows it to be integrated into the mask body. Also, a battery can provide a conveniently long supply of electricity.

Preferably, the electrical energy source has a voltage in an area of between approximately 0.5 volts and approximately 7 volts, and particularly of approximately 3 volts or approximately 5 volts. This allows the electrical energy source or battery to provide expedient current flow through the mask body. Particularly in combination with the conductor fabric materials described below, a current flow can be generated that enables efficient elimination of pathogens in the mask body.

The protective mask is preferably designed to generate an electric, magnetic, or electromagnetic field (hereinafter collectively referred to as “field”) by means of the flow of current through the conductor fabric of the mask body. The field can be defined by the electrical resistance as determined by the materials or structure of the conductor fabric. For example, a suitable electrical resistance can be determined using the conductor fabric materials and structure described below.

The field can, in addition or as an alternative to the current flow, render the pathogens harmless, and in particular not only those located on the conductor fabric, but also those in more or less immediate proximity to the conductor fabric. In a similar manner, the field also destroys proteins or cell walls of the pathogens. Viruses in particular, which are typically negatively charged, can be efficiently rendered harmless by the field. Thus, pathogens are killed or incapacitated and remain permanently inactive. In addition, pathogens located in gaps between the protective mask and the face of its carrier that are not filtered out are also rendered harmless by the field. Particularly efficient destruction of pathogens can thus be achieved.

In this context, the protective mask is preferably designed so that the electric, magnetic or electromagnetic field has an alternating polarity. The alternating polarity of the electric, magnetic or electromagnetic field can be efficiently generated by an alternating current, for example. Or it can be generated by a circuit that changes the polarities at the current coupling structure cyclically or continuously. Due to the changing polarity of the field, pathogens can be rendered harmless even more efficiently and, above all, more completely. For example, individual pathogens can be prevented from reaching the field under the protection of other structures or behind other structures. The pathogens “hidden” in this manner can also be reached by the changing field.

Preferably, the electric, magnetic and/or electromagnetic field can be generated in Gaussian waves. In this manner, current can be applied to the mask body in a manner similar to earthquake waves or shock waves, which enables particularly efficient elimination of viruses and other pathogens in the mask body.

The conductor fabric may have polyamide or be produced from polyamide. A conductor fabric made of polyamide can be soft and stretchy, which can give a comfortable feeling for the carrier of the protective mask and thus increase the acceptance of wearing the protective mask. In addition, polyamide can enable a comparatively robust and elastic design of the conductor fabric, which can ensure or increase the functionality of the protective mask. The conductor fabric can have a comparably high electromagnetic shielding capability.

The conductor fabric is preferably metallized to increase or adjust the current conductivity. The metal used for metallization may have, for example, copper, nickel, zinc or tin. The metal can be suitably selected as required, for example to improve conductivity, in shielding performance, in corrosion protection or in abrasion resistance.

Preferably, the metal used for metallization comprises or consists of silver, in particular substantially pure or approximately 99% pure silver. Silver has an electrical conductivity that allows a suitable current flow under the conditions present in the protective mask. In addition, silver can already have a disinfecting effect even without current flow. Thus, silver exposed to electricity can render pathogens harmless in two ways, thereby increasing the efficiency of the protective mask.

For example, the conductor fabric can be metallized by adding metal to its surfaces. Alternatively, or complementarily, the conductor fabric preferably comprises fibers, wherein the conductor fabric is metallized by laminating the fibers of the conductor fabric with the metal and particularly silver. The conductor fabric with fibers can advantageously be designed as a non-woven fabric. Such non-woven fabrics generally represent structures made of fibers of limited length, continuous fibers or filaments, respectively, or chopped yarns of any kind and any origin, wherein the fibers are joined together in some way to form the non-woven fabric or a fiber layer or a fiber pile, respectively, and are connected to one another in some way. Typically, non-woven fabrics do not include structures formed by interlacing or intertwining yarns, as occurs in weaving, knitting, lacemaking, braiding, and the production of tufted products. However, the conductor fabric with the fibers can also be designed as a mixed form of non-woven fabric and other structures.

Preferably, the conductor fabric comprises carbon and, in particular, carbon fibers. Carbon and particularly carbon fibers can be used to adjust important properties of the conductor fabric.

For example, carbon or carbon fibers can be provided in the conductor fabric to adjust or adapt the hydrophilicity or hydrophobicity of the conductor fabric. In particular, carbon or carbon fibers have a comparatively high hydrophilicity, so that any undesirable hydrophobic properties of metal laminated fibers such as silver laminated polyamide fibers or other fibers can provide a suitable hydrophilicity of the entire conductor fabric. This ensures that liquid or aerosols remain sufficiently suspended in the conductor fabric so that any pathogens present in the mask body can be efficiently rendered harmless.

Carbon or carbon fibers can also be provided to adjust the electrical resistance of the conductor fabric. For example, this can be used to counteract insufficient electrical resistance, as is the case, among other things, with metallized non-woven fabrics and particularly with non-woven fabrics made from silver-laminated polyamide fibers. Thus, there may be a matched electrical resistance in the conductor fabric that allows the generation of a current flow in the mask body that can be used to efficiently render pathogens harmless.

In a preferred embodiment, the conductor fabric has a back surface facing a user's face when the protective mask is in use, wherein the conductor fabric is designed as a non-woven fabric of silver-laminated polyamide fibers interlaced with carbon fibers on the back surface of the conductor fabric.

In another preferred embodiment, the conductor fabric comprises a first fabric layer of silver-laminated polyamide fibers and a second fabric layer of carbon. In addition to the carbon or carbon fibers, the second fabric layer can also comprise other components or fibers.

The term “laminated” in the context of metallization of the conductor fabric refers to coating of a carrier material in any suitable form. The metal or silver can be thermally bonded to the fibers or polyamide fibers as carrier material. Or the carrier material or the (polyamide) fibers can be coated with the metal or silver in an electrolytic bath (electroplating). Other similar suitable coating processes can also be used and are understood here as lamination.

Such conductor fabrics with silver-laminated polyamide fibers enable an effect particularly adapted to the elimination of pathogens and at the same time a particularly high wearing comfort of the protective mask. By means of such a conductor fabric, an appropriately large current flow or an appropriately large electric or magnetic or electromagnetic field can be generated over the entire surface of virtually the entire body of the mask, so that pathogens can be reliably and efficiently eliminated from the air breathed or the air breathed can be efficiently sterilized.

The provision of the first and second fabric layers enables a particularly efficient and targeted provision of a silver-polyamide braid provided with carbon. In this case, the first fabric layer and the second fabric layer are preferably connected to each other via a connection layer. Such a connection enables efficient production of the conductor fabric. In particular, the connection layer is preferably an adhesive layer such as a hot-melt adhesive layer.

The conductor fabric preferably has a thickness of from 0.1 millimeter (mm) to 0.4 mm, from 0.2 mm to 0.3 mm, or from 0.26 mm to 0.272 mm. The thickness of the conductor fabric can have an effect on the electrical resistance of the mask body. In particular, by providing a suitable thickness of the conductor fabric as a function of the materials of the conductor fabric, a suitable electrical resistance can be provided so that efficient rendering harmless of pathogens can be achieved. In addition, depending on the type of materials used, the breathing resistance or the breathing capacity of the mask body can be adjusted via an adapted thickness. The above thickness ranges are particularly advantageous for a non-woven fabric made of silver-laminated polyamide fibers interlaced with carbon fibers on the reverse side.

Preferably, the conductor fabric has an electrical resistance that is at least approximately 8 ohms (Ω) and particularly at least approximately 12Ω. With such an electrical resistor, the provision of a current flow suitable for rendering pathogens harmless and, at the same time, a comparatively high degree of wearing comfort can be achieved. Particularly using the materials and designs of the conductor fabric described above, an electrical resistance in the area indicated may be advantageous.

In this case, the electrical resistance of the conductor fabric is preferably approximately 50Ω. With such a limited electrical resistance it can be achieved that at the same time a suitable current flow is provided and on the other hand the current consumption is not too high. In particular, when using an electrical energy source or a battery that provides voltage in the area described above, a suitable current flow can be generated, and a suitable battery life can be achieved. For example, the suitable battery life may be at least one day.

The mask body may have a second layer designed as an air filter. The second layer can be an air filter in accordance with one of the standards N95, FFP2, FFP3, KN 95 or higher. This second layer can provide increased security. This can be particularly advantageous if the carrier of the protective mask is himself infected with a virus or if the carrier is in permanent contact with infected persons. In addition, the air filter can be important for certification. However, the air filter is particularly important for the filtration of aerosols. The conductor fabric or the field generated in it can render the pathogens in the aerosols trapped or stuck in the air filter harmless.

The second layer is preferably removably arranged in or on the mask body. This facilitates the insertion or removal of the second layer as needed. For example, the second layer can thus be easily replaced on a regular basis.

The mask body may have a third layer constructed in accordance with the first layer. In particular, the third layer may be quasi-identical in structure to the first layer and, more importantly, may be provided with an electrically conductive conductor fabric. In this case, the protective mask has two layers of conductor fabric that render the pathogen harmless. This can further increase the efficiency or effectiveness of the mask. The first and third layers are advantageously electrically coupled to one another. Thus, they can be powered together by a common electrical energy source and a common control unit.

Advantageously, the third layer is detachably connected to the first layer. For example, the first layer and the third layer may be connected to one another by means of snap buttons. Such snap buttons or similar elements enable efficient and convenient fastening of the two layers to each other and at the same time also electrical coupling of the two layers. In this manner, the two layers can be efficiently powered together by an electrical energy source.

The second layer is preferably arranged between the first layer and the third layer. In this manner, the filter can be cleanly embedded and the pathogens hanging in the filter can be rendered harmless by the first and third layers.

In a second aspect, the present invention is a protective mask having a mask body designed to be worn by a person so as to cover a mouth and a nose of the person. The mask body has a first layer having an electrically conductive conductor fabric. The conductor fabric is metallized and comprises carbon.

By metallizing the conductor fabric and adding carbon, electron flow can be efficiently created between these two materials. For this purpose, the protective mask can be actively electrified or energized as described above, or passively exposed to an electric, magnetic or electromagnetic field. As a result, electron jumps may be present, which can be responsible for extremely effective and efficient sterilization. In particular, viruses and other pathogens held in the mask body can be eliminated efficiently. In particular, the protective mask can filter aerosols and other fabrics from the breathing air and at the same time render viruses and other pathogens harmless. This can take advantage of the fact that viruses are negatively charged proteins and can thus be rendered harmless by the electrical energy in the mask body.

Further, by providing the electrical conductor fabric with carbon, the properties of the conductor fabric can be adjusted as required.

For example, carbon or carbon fibers can be provided in the conductor fabric to adjust or adapt the hydrophilicity or hydrophobicity of the conductor fabric. Carbon has a comparatively high hydrophilicity, so that any undesirable hydrophobic properties of the metallized conductor fabric, such as silver-laminated polyamide fibers, can be reduced and an adapted hydrophilicity of the entire conductor fabric can be provided. This ensures that liquid or aerosols remain sufficiently suspended in the conductor fabric so that any pathogens present in the mask body can be efficiently rendered harmless.

Carbon or carbon fibers can also be provided to adjust the electrical resistance of the conductor fabric. For example, this can be used to counteract insufficient electrical resistance, as is the case, among other things, with metallized non-woven fabrics and particularly with non-woven fabrics made from silver-laminated polyamide fibers. Such insufficient resistance could, for example, lead to short-circuit currents and/or to undesirably high temperatures in the protective mask. However, by means of the carbon in the conductor fabric, there can be an adapted electrical resistance in the conductor fabric, which enables the generation of an electrostatic charge of the mask body or a current flow in the mask body, with which pathogens and particularly viruses can be efficiently rendered harmless.

With the protective mask of the second aspect of the invention and its preferred embodiments described below, effects and advantages described above of the protective mask of the first aspect of the invention and its preferred embodiments can be efficiently realized.

Some preferred embodiments of the protective mask of the second aspect of the invention are described below, the effects and advantages of which correspond to the corresponding embodiments of the protective mask of the first aspect of the invention, unless otherwise stated below.

Preferably, the conductor fabric comprises polyamide.

Preferably, the conductor fabric comprises fibers and the conductor fabric is metallized by laminating the fibers of the conductor fabric with metal.

The metal preferably has silver and in particular substantially pure silver such as at least 99% silver.

In a preferred embodiment, the conductor fabric has a back side facing a face of a user when the protective mask is in use, and the conductor fabric is designed as a non-woven fabric of silver-laminated polyamide fibers interlaced with carbon fibers on the back side of the conductor fabric.

In a further preferred embodiment, the conductor fabric comprises a first fabric layer of silver-laminated polyamide fibers and a second fabric layer of carbon. In this case, the first fabric layer and the second fabric layer are preferably connected to each other via a connection layer. The connection layer is preferably an adhesive layer and particularly a hot-melt adhesive layer.

Such conductor fabrics with silver-laminated polyamide fibers enable an effect particularly adapted to the elimination of pathogens and at the same time a particularly high wearing comfort of the protective mask. By means of such a conductor fabric, an appropriately large current flow or an appropriately large electric or magnetic or electromagnetic field can be generated over the entire surface of virtually the entire body of the mask, so that pathogens can be reliably and efficiently eliminated from the air breathed or the air breathed can be efficiently sterilized.

Preferably, the conductor fabric has a thickness of from 0.1 millimeter to 0.4 millimeter, from 0.2 millimeter to 0.3 millimeter, or from 0.26 millimeter to 0.272 millimeter.

Preferably, the conductor fabric has an electrical resistance that is at least approximately 8 ohms and particularly at least approximately 12 ohms. In this case, the electrical resistance of the conductor fabric is preferably at most approximately 50 ohms.

Preferably, the mask body has a second layer designed as an air filter.

Preferably, the mask body has a third layer constructed in accordance with the first layer. In this case, the second layer is preferably arranged between the first layer and the third layer. The second layer is preferably provided removably in the mask body.

In a third aspect, the present invention is a method of production of a conductor fabric and in particular a conductor fabric for a mask body of a protective mask. The method comprises the steps of: (i) providing a first fabric layer of silver laminated polyamide fibers; (ii) providing a second fabric layer of carbon; (iii) providing a connection layer; and (iv) connecting the first fabric layer to the second fabric layer by means of the connection layer.

By means of the method according to the invention, the conductor fabric can be produced in a particularly efficient manner.

Preferably, the connection layer is an adhesive layer in step (iv), the first fabric layer is bonded to the second fabric layer by means of the adhesive layer.

Here, preferably, the adhesive layer is a hot-melt adhesive layer, and step (iv) comprises heating the hot-melt adhesive layer.

Preferably, step (iv) comprises conveying the first fabric layer, the second fabric layer, and the intervening connection layer through two rollers. In this way, pressure and, if necessary, heat can be applied to the three layers in a controlled manner. This enables an efficient and purposeful connection of the three layers and creation of the conductor fabric.

In this case, the two rollers can preferably be inflated and, in particular, inflated in a controlled manner. In this way, a target pressure can be specifically generated between the rollers that is adapted to the connection of the first and second fabric layers by means of the connection layer.

The two rollers are preferably configured to convey the first fabric layer, the second fabric layer, and the connection layer at a speed in an area ranging from approximately 10 meters per minute (m/min) to approximately 20 m/min, and particularly at a speed of approximately 15 m/min.

Preferably, in step (iv), the first fabric layer, the second fabric layer, and the connection layer are exposed to a temperature in an area of approximately 90° C. to approximately 200° C., preferably to a temperature in an area of approximately 140° C. to approximately 180° C., and particularly to a temperature of approximately 160° C.

In a fourth aspect, the present invention is a use of a conductor fabric produced by the method according to the invention in a protective mask and in particular a respirator. In this case, the conductor fabric is preferably provided in a mask body designed to cover a mouth and nose of a person.

With the use according to the invention, the effects and advantages described above can be achieved.

### BRIEF DESCRIPTION OF THE DRAWINGS

Further advantageous embodiments of the invention emerge from the following description of exemplary embodiments of the invention with the aid of the schematic drawing. In particular, the protective mask according to the invention is described in more detail below with reference to the accompanying drawings by means of embodiment examples.

FIG. 1 shows a protective mask according to an embodiment of the present invention.

FIG. 2 shows a conductor fabric in the protective mask according to an embodiment of the present invention.

FIG. 3 shows the protective mask with a power connector as a power coupling structure, and a placeholder for a battery and a control unit, respectively, according to an embodiment of the present invention.

FIG. 4 shows a housing attached to the mask body according to an embodiment of the present invention.

FIG. 5 shows the protective mask with the housing removable from the mask body according to an embodiment of the present invention.

### DETAILED DESCRIPTION

Certain expressions are used in the following description for practical reasons and are not to be understood as limiting. The words “right,” “left,” “bottom” and “top” denote directions in the drawing to which reference is made. The expressions “inward,” “outward,” “below,” “above,” “on the left,” “on the right” or the like are used to describe the arrangement of designated parts relative to one another, the movement of designated parts relative to one another and the directions toward or away from the geometric center of the invention and designated parts thereof as shown in the figures. This spatial relative information also comprises other positions and orientations than those shown in the figures. For example, when a part shown in the figure is inverted, elements or features that are described as “below” are then “above.” The terminology comprises the words expressly mentioned above, their derivations and words with similar meanings.

In order to avoid repetition in the figures and the associated description of the various aspects and exemplary embodiments, certain features are to be understood collectively for different aspects and exemplary embodiments. The omission of an aspect in the description or in a figure does not suggest that this aspect is lacking in the associated exemplary embodiment. Rather, such omissions are made for the sake of clarity and to avoid repetition. In this context, the following stipulation applies to the entire further description: If reference numerals are contained in a figure for the purpose of graphic unambiguity but are not mentioned in the directly associated descriptive text, reference is made to their explanation in preceding figure descriptions. If reference signs are also mentioned in the text of the description relating directly to a figure that are not included in the corresponding figure, reference is made to the preceding and following figures. Similar reference signs in two or more figures represent similar or identical elements.

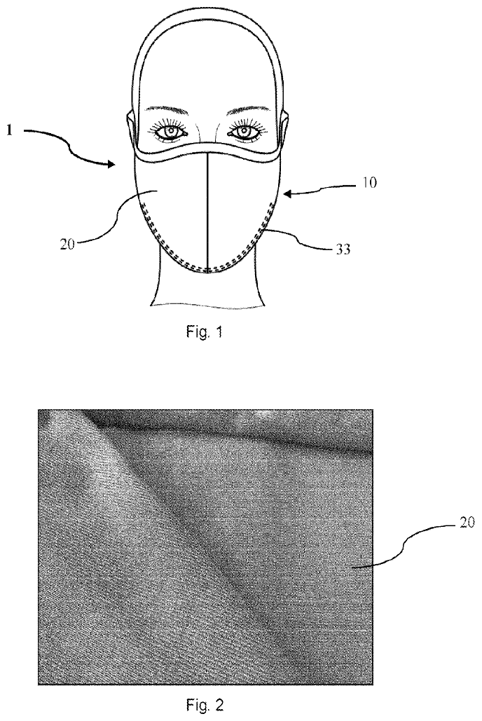

FIG. 1 shows a protective mask according to the present invention. The protective mask 1 can be worn by a person while covering his nose and mouth to clear the inhaled and exhaled breath through the protective mask. The protective mask has a mask body 10 that covers the nose and mouth. The mask body 10 may have a first layer made of an electrically conductive conductor fabric 20.

FIG. 2 shows the conductor fabric 20, which comprises a first fabric layer made of a non-woven fabric. The non-woven fabric comprises polyamide fibers laminated with quasi-pure silver. Further, the conductor fabric comprises a second fabric layer made of carbon fibers and a connection layer connecting the non-woven fabric and the second fabric layer. The connection layer is a hot melt adhesive layer.

As an alternative to the second fabric layer, the non-woven fabric can also be interlaced with carbon fibers on the reverse side.

The conductor fabric 20 is approximately 0.27 mm thick and has an electrical resistance of approximately 15Ω.

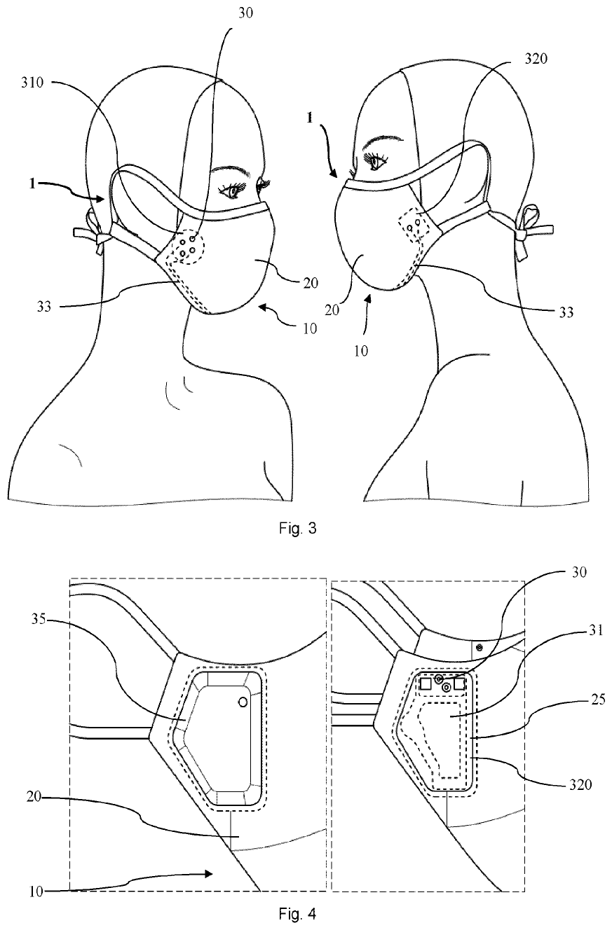

FIG. 3 shows the protective mask 1 according to the present invention. The protective mask 1 has a power connector 30 as a power coupling structure, and a battery placeholder 320 or placeholder for a battery 32 as an electrical energy source in a first lateral area of the mask body 10, and a control unit placeholder 310 or placeholder for a control unit 31 in an opposite second lateral area of the mask body 10. The battery 32 and the control unit 31 and their placeholders 310, 320, respectively, are electrically connected to the conductor fabric 20 via the power connection 30 to generate a current flow therein. An intermediate connection 33 or intermediate line connects the battery 32 and the control unit 31 or its placeholders 310, 320. This allows switching on and off and controller of the current flow. The battery 32 has a voltage of approximately 5 volts.

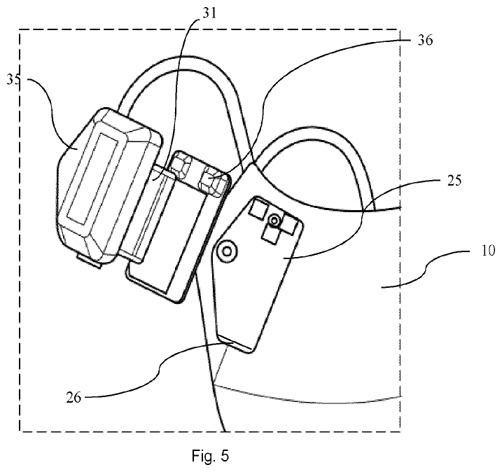

FIG. 4 shows an example of one of two housings 35 in which the battery 32 or the control unit 31 are arranged at their placeholders 310, 320. The housings 35 are each removably arranged on the mask body 10 via corresponding holders 25. The current flow is generated in the conductor fabric 20 directly from the battery 32 regulated by the control unit.

FIG. 5 shows the housing 35 with the control unit 31. The mask body 10 is detachably fastened to the holder 25. The housing 35 can be detachably fastened to the holder 25. For this purpose, the holder 25 has a locking groove 26 into which the housing can be inserted. In addition, a magnetic unit 36 is provided by which the housing 35 is held to the holder 25. The housing 35 may be opened to remove the control unit 31 therefrom. Similarly, the housing 35 for the battery 32 and the holder 25 is designed in the opposite lateral area of the mask body 10.

Although the invention is illustrated and described in detail by means of the figures and the accompanying description, such illustration and detailed description are to be understood as illustrative and exemplary and do not limit the invention. In order not to obscure the invention, well-known structures and techniques may not be shown and described in detail in certain cases. It is understood that a person skilled in the art can make changes and modifications without departing from the scope of the following claims. In particular, the present invention covers further exemplary embodiments with any combinations of features that may deviate from the explicitly described feature combinations. For example, the invention may also be implemented in a form in which the battery and the control unit are separate and are connected to the mask body by a cable with the power connector.

The present disclosure also includes embodiments having any combination of features that are mentioned or shown above or below with respect to various embodiments. It also includes individual features in the figures, even if they are shown there in connection with other features and/or are not mentioned above or below. Alternatives of embodiments described in the figures and the description and individual alternatives of their features can also be excluded from the subject matter of the invention or from the disclosed subject matter. The disclosure includes embodiments comprising exclusively the features described in the claims or in the exemplary embodiments and those comprising additional features.

Furthermore, the expression “comprise” and derivations thereof do not exclude other elements or steps. Likewise, the indefinite article “a” or “an” and derivations thereof do not exclude a plurality. The functions of several features listed in the claims can be performed by one unit or one step. The mere fact that certain measures are listed in different dependent claims does not mean that a combination of those measures cannot be used advantageously. The terms “substantially,” “approximately,” “about” and the like, when used in conjunction with a property or value, in particular also define precisely that property or that value. The terms “approximately” and “about,” when used in connection with a given numerical value or range, can refer to a value or range that is within 20%, within 10%, within 5% or within 2% of the given value or range.

1. A protective mask comprising:
a mask body designed to be worn by a carrier so as to cover a mouth and a nose of the person,
wherein the mask body has a first layer having an electrically conductive conductor fabric, and
wherein the conductor fabric is metallized and comprises carbon.

2. The protective mask according to claim 1, comprising a current coupling structure through which an electric current is injectable into the mask body so as to generate a current flow through the conductor fabric.

3. The protective mask according to claim 2, comprising a control unit and an electrical energy source electrically connected to one another and to the current coupling structure.

4. The protective mask of claim 3, comprising
at least one housing,
wherein the mask body is provided with at least one holder,
wherein the at least one housing encloses the electrical energy source and the control unit and is attached to the at least one holder of the mask body, and
wherein preferably the at least one housing comprises two housings and the at least one holder comprises two holders.

5. (canceled)

6. The protective mask according to claim 3, wherein the control unit and the electrical energy source are designed to feed the electrical current into the mask body in a clocked manner via the current coupling structure.

7. The protective mask according to claim 6, wherein a cycle of the electric current lasts between approximately 2 seconds and approximately 10 seconds, and in particular approximately 5 seconds, and/or
wherein the control unit and the electrical energy source are designed to inject the electrical current in the form of Gaussian waves in a clocked manner into the mask body via the current coupling structure.

8. (canceled)

9. The protective mask according to claim 3, comprising a signal unit electrically connected to the control unit, wherein the control unit is designed to activate the signal unit when a capacity of the electrical energy source is below a predefined minimum capacity value.

10. The protective mask according to claim 3, comprising a humidity sensor electrically connected to the control unit and coupled to the conductor fabric, wherein the control unit is designed to inject the electric current into the mask body via the current coupling structure when a humidity determined by the humidity sensor is above a predefined basic humidity value.

11. The protective mask according to claim 3, wherein the electrical energy source comprises a battery, and/or
wherein the electrical energy source comprises a photovoltaic cell.

12. (canceled)

13. The protective mask according to claim 3,
wherein the electrical energy source has a voltage in an area of between approximately 0.5 volts and approximately 7 volts, and particularly of approximately 3 volts or approximately 5 volts, and/or
wherein the protective mask is configured such that an electric, magnetic or electromagnetic field can be generated by the flow of current through the conductor fabric of the mask body, and/or
wherein the protective mask is configured for the electric, magnetic or electromagnetic field to have an alternating polarity, and/or
wherein the protective mask is configured such that the electric, magnetic or electromagnetic field can be generated in Gaussian waves.

14. (canceled)

15. (canceled)

16. (canceled)

17. The protective mask according to claim 1, wherein the conductor fabric comprises polyamide, and/or wherein the conductor fabric comprises fibers and is metallized by laminating the fibers of the conductor fabric with metal.

18. (canceled)

19. The protective mask according to claim 1, wherein the metal has silver, preferably substantially pure silver such as at least 99% silver.

20. The protective mask according to claim 19,
wherein the conductor fabric has a back side facing a face of a user in use of the protective mask, and wherein the conductor fabric is designed as a non-woven fabric of silver-laminated polyamide fibers interlaced with carbon fibers at the back side of the conductor fabric, or
wherein the conductor fabric comprises a first fabric layer of silver laminated polyamide fibers and a second fabric layer of the carbon.

21. (canceled)

22. The protective mask according to claim 20, wherein the first fabric layer and the second fabric layer are connected to one another via a connection layer, and wherein the connection layer preferably is an adhesive layer and in particular a hot melt adhesive layer.

23. (canceled)

24. The protective mask according to claim 1, wherein the conductor fabric has a thickness of from 0.1 millimeter to 0.4 millimeter, from 0.2 millimeter to 0.3 millimeter, or from 0.26 millimeter to 0.272 millimeter.

25. The protective mask according to claim 1, wherein the conductor fabric has an electrical resistance that is at least approximately 8 ohms and in particular at least approximately 12 ohms, and wherein the electrical resistance of the conductor fabric preferably is at most approximately 50 ohms.

26. (canceled)

27. The protective mask according to claim 1, wherein the mask body has
a second layer which is designed as an air filter, and/or
a third layer which is constructed in accordance with the first layer,
wherein preferably, the second layer is arranged between the first layer and the third layer, and/or the second layer is removably provided in the mask body.

28. (canceled)

29. (canceled)

30. (canceled)

31. A method for producing a conductor fabric and in particular a conductor fabric for a mask body of a protective mask in accordance with claim 1, comprising:
(i) providing a first fabric layer of silver laminated polyamide fibers;
(ii) providing a second fabric layer comprising carbon;
(iii) providing a connection layer; and
(iv) connecting the first fabric layer to the second fabric layer by means of the connection layer.

32. The method according to claim 31, wherein the connection layer is an adhesive layer, and wherein in step (iv) the first fabric layer is adhered to the second fabric layer by the adhesive layer, and wherein preferably the adhesive layer is a hot melt adhesive layer, and wherein step (iv) comprises heating the hot melt adhesive layer.

33. (canceled)

34. The method according to claim 31, wherein step (iv) comprises conveying the first fabric layer, the second fabric layer, and the intervening connection layer through two rollers, which are preferably inflatable and particularly inflatable in a controlled manner,
wherein the two rollers are preferably configured to convey the first fabric layer, the second fabric layer and the connection layer at a speed in an area of approximately 10 m/min to approximately 20 m/min and particularly at a speed of approximately 15 m/min, and/or
wherein in step (iv) the first fabric layer, the second fabric layer, and the connection layer are exposed to a temperature in an area of approximately 90° C. to approximately 200° C., preferably to a temperature in an area of approximately 140° C. to approximately 180° C., and particularly to a temperature of approximately 160° C.

35. (canceled)

36. (canceled)

37. (canceled)

38. A method comprising a step of providing a conductor fabric produced by a method according to claim 31 in a protective mask and in particular a respirator, wherein the conductor fabric preferably is provided in a mask body designed to cover a mouth and nose of a person.

39. (canceled)
